(19) United States
(12) Patent Application Publication
(10) Pub. No.: US 2011/0238873 A1
(43) Pub. Date: Sep. 29, 2011

(54) DOCUMENT FINISHING DEVICE, AND METHOD FOR CONFIGURING SUCH A DEVICE

(75) Inventor: Anne A. WIND, Eindhoven (NL)

(73) Assignee: OCE TECHNOLOGIES B.V., Venlo (NL)

(21) Appl. No.: 13/109,703

(22) Filed: May 17, 2011

Related U.S. Application Data
(63) Continuation of application No. PCT/EP2009/064580, filed on Nov. 4, 2009.

(30) Foreign Application Priority Data
Nov. 17, 2008 (EP) 08169236.0

(51) Int. Cl. G06F 13/14

(52) U.S. Cl. 710/74

(57) ABSTRACT

A method for configuring a document finishing device, such as a folding, binding or stapling machine, includes the steps of storing data referring to the selected command on a portable data storage device, connecting the portable data storage device to the document finishing device and reading the data from the data storage device into the document finishing device and configuring a functionality of at least one key of the document finishing device, based on data read from the data storage device. A document finishing device and a portable data storage device for carrying out the method are also provided.

### CROSS-REFERENCE TO RELATED APPLICATIONS

This application is a Continuation of copending PCT International Application No. PCT/EP2009/064580 filed on Nov. 4, 2009, which designated the United States, and on which priority is claimed under 35 U.S.C. §120. This application also claims priority under 35 U.S.C. §119(a) on Application No. 08169236.0, filed in Europe on Nov. 17, 2008. The entire contents of each of the above documents is hereby incorporated by reference into the present application.

### BACKGROUND OF THE INVENTION

1. Field of the Invention:

The present invention relates to a method for configuring a document finishing device, such as a folding, binding or stapling machine, and to a method for configuring such a device.

2. Description of Background Art:

Document finishing devices, such as folding, binding or stapling machines often offer a lot of possibilities to users, but only a limited subset of these possibilities is used throughout the life span of the product. For example, a folding machine may be able to fold a large range of paper formats, according to a variety of folding ways, but a user typically only uses one or two paper formats, which are folded according to one or two folding ways. Nevertheless, it is desired that all possibilities of the device are in principle available to a user, but it is undesired that a user interface of the device include all of the possibilities, since this often requires an extended keyboard, or even a display device.

### SUMMARY OF THE INVENTION

It is an object of the present invention to take away the need for such an extended keyboard or a user interface, while maintaining the full range of possibilities offered.

An aspect of the present invention is directed to a method for configuring a document finishing device, such as a folding, binding or stapling machine, comprising the steps of: (A) storing data referring to a command on a portable data storage device; (B) connecting the portable data storage device to the document finishing device; (C) reading the data from the data storage device into the document finishing device; and (D) configuring a functionality of at least one physical key of the document finishing device, based on data read from the data storage device. One data storage device may be used to store commands for several document finishing devices, and physical keys may comprise buttons and other touch-enabled sensors, or even a touch-screen.

Step (A) is in general performed only once for each user. After that, a user can take his personal portable storage device to the apparatus when the use of the document finishing device is desired, connect the portable data storage device to the document finishing device (B) and have the data read into the document storage device (C), upon which the at least one key of the data storage device is configured (D), and the document finishing device can be used. Step (B) may comprise connecting the device wirelessly. The present invention may further comprise the step (E) of selecting the command from a set of commands executable by the device.

Herein, various users may store their own personal key configurations on their own data storage device, which can be embodied by a USB stick, a CD-ROM, a Bluetooth enabled device, a magnetic card or any other portable machine readable device to which data can be written.

Performing step (A), and thus writing data to the portable data storage device may be performed on a computer having at least a display, such as a personal computer, a laptop or a PDA. The computer should therefore be provided with a set of commands executable by the device. A software application, provided for example by the manufacturer of the document finishing device, may be run on the computer for that goal. This application can be installed locally on the computer, or be run from a CD-Rom or a website. In this way, an efficient use is made from the hardware already present in the local area where the document finishing device is placed.

Preferably, executing the software for performing step (A) comprises running a so-called wizard application on the display device, for guiding a user at least in performing step (A), and for example also step (E). A wizard is a software program that leads a user through the necessary steps to be performed. Here, it presents the commands executable by the document finishing device to the user, so the user can assign a subset of these commands to the programmable keys available on the document finishing device, and it assists the user in saving or storing these commands on the portable data storage device.

In an embodiment, the method according to the present invention further comprises the steps of: (F) storing operating software for the document finishing device on the data storage device; and (G) updating the document finishing device with the operating software. Operating software is to be understood as software the document finishing device needs to perform a desired function. This software, also called firmware, is loaded into the device by the manufacturer. From time to time, updates or improved (newer) versions of this firmware may be present, which then need to be loaded into the device. Instead of sending a technician to the document finishing device, the document finishing device may be adapted to scan a portable data storage device for firmware updates, and to replace or update its presently loaded software with the update. Just like reading the data comprising commands to be associated with the physical keys, the software-updates may be read from the data storage device wirelessly, for example with Bluetooth.

The method according to the present invention may further comprise the step of (H) generating a legend of the configured keys on the device. The document finishing device may thereto be equipped with an area that is configured to receive the legend. This area may be close to, or even on the keys, and may preferably be equipped with a transparent cover behind which a paper printed copy of the names of the key commands can be exposed.

In the above context the present invention relates to a method for configuring a document finishing device, such as a folding, binding or stapling machine, comprising the steps of: (A) storing data relating to at least one command executable by at least one document finishing device on a portable data storage device; (B) connecting the portable data storage device to the document finishing device; (C) reading the stored data from the data storage device into the document finishing device; and (D) assigning the selected command to at least one physical key of the document finishing device, based on the data read from the data storage device. The method may comprise the step of (E) selecting, before step (A), at least one command from a set of commands executable by at least one document finishing device. In an embodiment step (A) is performed by means of a computer comprising a display, wherein this embodiment may comprise running a wizard application on the computer for guiding a user. In an embodiment, the method may further comprise the steps of (F) storing operating software for the document finishing device onto the data storage device prior to connecting the portable data storage device to the document finishing device according to step (B); and (G) updating the document finishing device with the operating software, after connecting the portable data storage device to the document finishing device according to step (B). In an embodiment, step (C) comprises wirelessly reading the data from the data storage device. It may be appreciated that the method may comprise the step of (H) generating a legend for the at least one physical key. This step (H) may comprise the step of providing a printed copy of the legend.

In another aspect, the present invention relates to a document finishing device, such as a folding, binding or stapling machine, in particular for performing any one or all of steps (A) to (H) and the alternatives as described hereinabove, wherein the document finishing device comprises: at least one configurable physical key for entering at least one command to the device; a data exchange interface configured to connect the document finishing device to a portable data storage device; a unit configured to read data from the data storage device; and a unit configured to assign at least one command to the at least one key, based on data read from the data storage device. In an embodiment of the document finishing device, the data exchange interface is a wireless interface and may comprise a data carrier for storing operational software.

In another aspect, the present invention also relates to a portable data storage device, comprising data relating to at least one command executable by a document finishing device as described hereinabove. The portable data storage device may further comprise operational software for the document finishing device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will now be explained further with reference to the accompanying drawings, wherein:

FIG. 1 shows a document finishing device 1, more in particular a paper folding machine;

FIG. 2 shows the device 1 from FIG. 1 from another perspective;

FIG. 3 shows a detailed partial view of the device from FIGS. 1 and 2;

FIG. 4a shows another detailed view of the document finishing device 1 from any of the previous figures; and

FIG. 4b shows a user, handling the piece of paper, that is being finished by the device 1 from FIG. 4a.

### DETAILED DESCRIPTION OF THE INVENTION

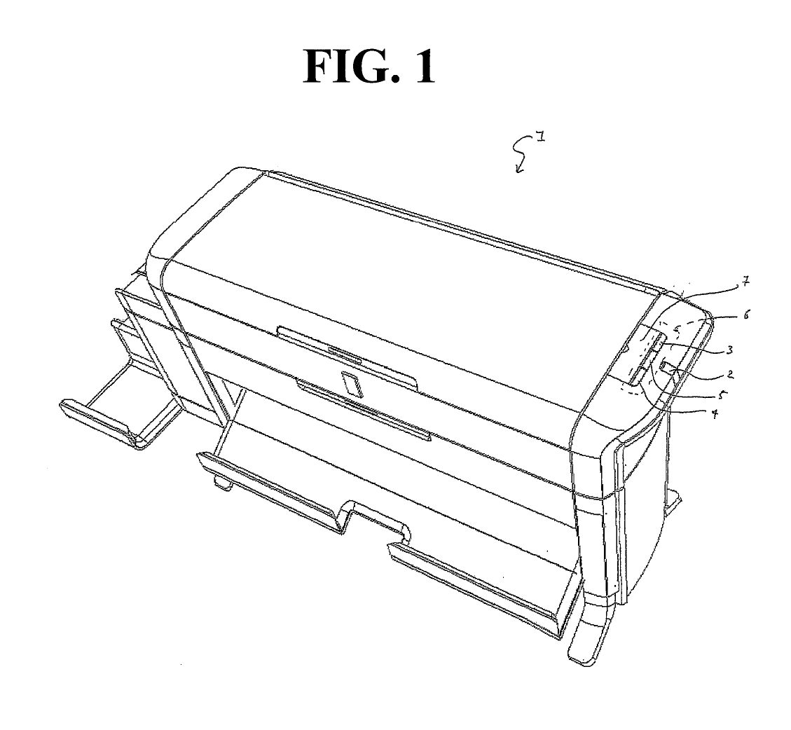

FIG. 1 shows a document finishing device 1, more in particular a paper folding machine. The document finishing device 1 is equipped with a USB connector 2, to which a portable data storage device (here embodied by a USB stick that is not shown) can be connected. The document finishing device 1 is configured to read data from the data storage device, and to configure the keys 3, 4, 5 from a keyboard 6 according to the data on the data storage device. The device 1 is furthermore configured to scan the portable data storage device for software updates, and to replace software already installed on the document finishing device 1 by software on the portable data storage device.

Adherent to the keyboard 6, a transparent window 7 is provided. The window is arranged such that a piece of printed paper can be placed under the window 7. The window 7 can be used to place a paper comprising names or icons referring to the commands that are coupled to the keys near the keys 3, 4, 5, so a user can visually determine the functions of the keys 3, 4, 5. The software on the PC of the user may be equipped to print such a paper, corresponding to the data recorded on the portable data storage device.

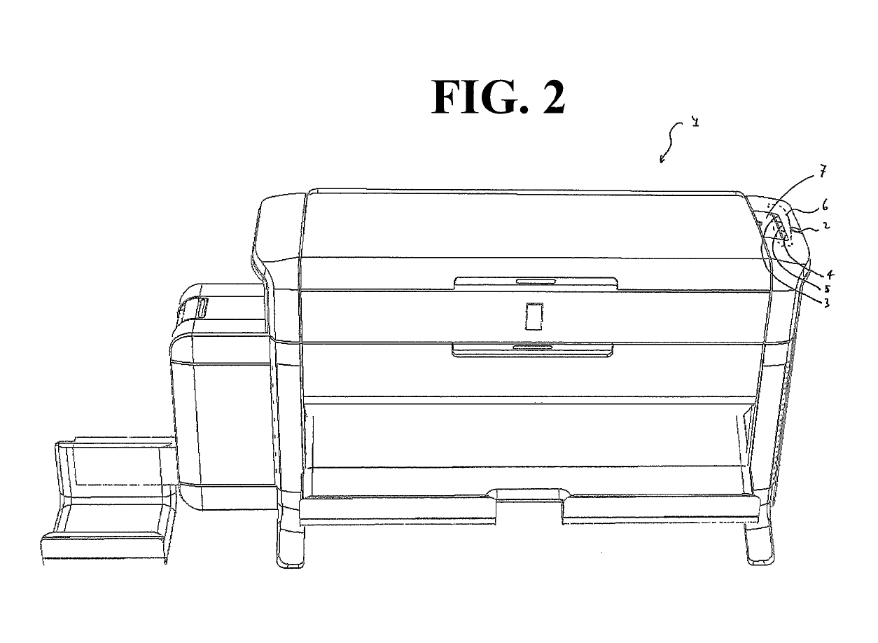

FIG. 2 shows the device 1 from FIG. 1 from another perspective, i.e. straight from the front-side. In FIG. 2, like reference numbers refer to like features from FIG. 1.

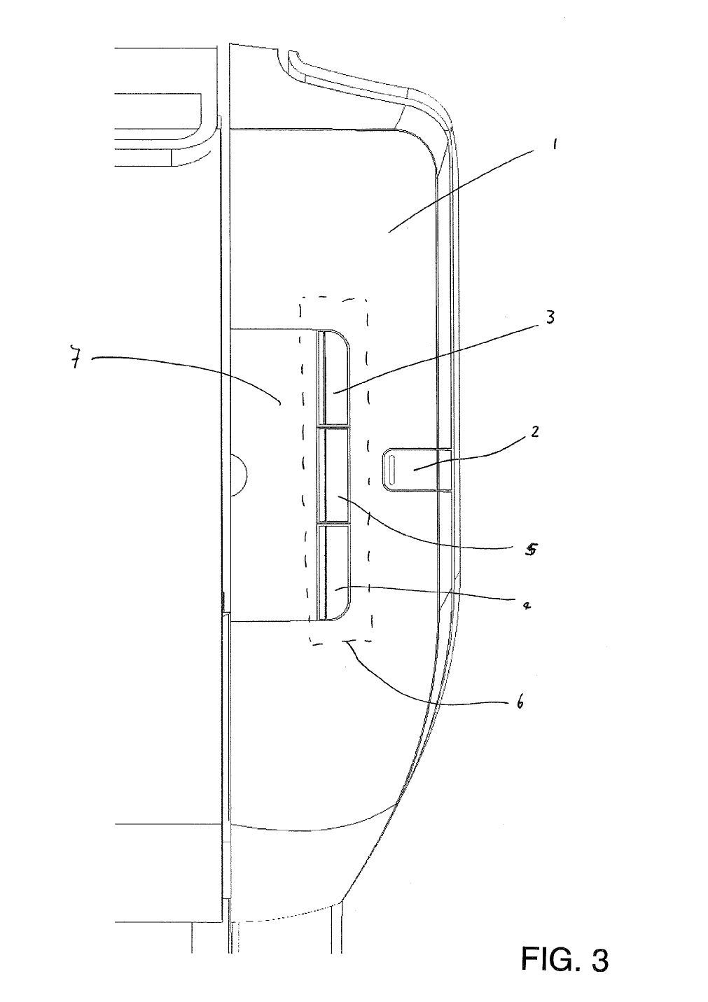

FIG. 3 shows a detailed partial view of the device from FIGS. 1 and 2. In particular, the keys 3, 4, 5 forming a keyboard 6 on the data storage device 1 are shown. Adherent to the keyboard 6, the transparent window 7 is visible, arranged such that a piece of printed paper can be placed under the window 7. Keys 3, 4, 5 read configuration data from a data storage device such that the functions of the keys 3, 4, 5 are configurable for users. This configuration may vary, e.g. for each specific end-user or may vary for each group of customers or type of customers. A piece of paper may act as a reminder for each user, or may alternatively act as a reminder for the configuration of all users together.

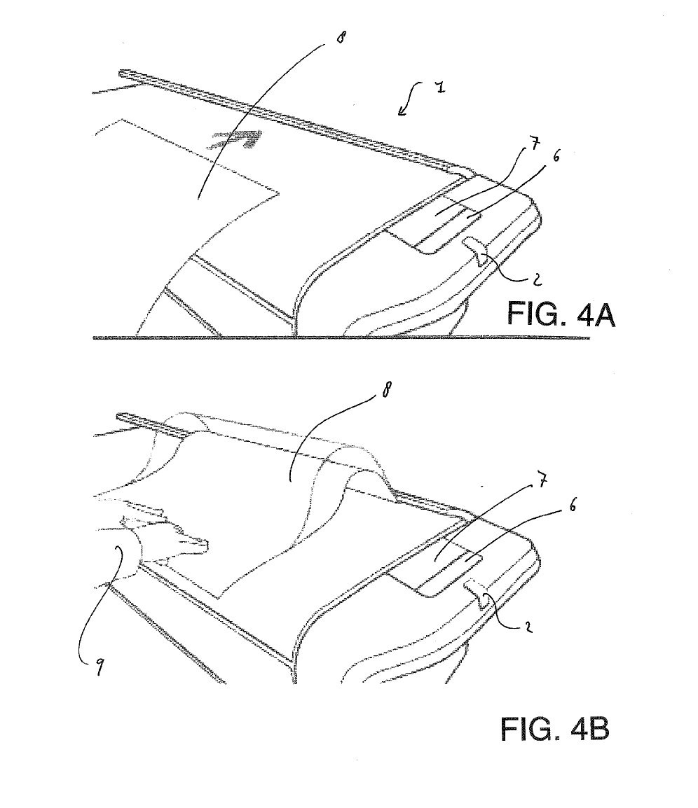

FIG. 4a shows another detailed view of the document finishing device 1 from any of the previous figures. A user (not shown) is putting a piece of paper to be folded according to a predetermined folding pattern or scheme on the document finishing device 1. The piece of paper may have various formats that can be handled by the folding machine. For example, the paper folding machine is able to handle standardized formats like A0 format, A1 format, A2 format, A3 format, A4 format, industrial drawing formats, or customized formats.

A user may define one or several presets for keys 3, 4, 5 on a workstation, or, e.g. download a set of presets for the configuration of the keys 3, 4, 5. A software wizard simplifies the definition of these presets, or alternatively a user uses a programming language to set the configurations. Such a software wizard enables a graphical user interface for the user to preset one or more finishing programs and optionally prints a piece of paper which may be placed behind a transparent cover as a reminder of the programmed presets. The programmed configurations of the keys 3, 4, 5 may now be stored on a portable storage device such as a USB device and thereby transferred to the finishing device permanently or temporarily during the actual usage of the finishing device.

After the user has coupled his portable data storage device to the USB connector 2, he can use the keyboard 6 to operate the device 1. Behind the transparent window 7, a piece of printed paper can be placed, in order to explain what folding operations are coupled to what keys of the keyboard 6. For example the first key may have the command to fold the piece of paper twice about it's length in different orientations and after that once about it's width assigned, so that a map-like folded piece of paper may be obtained. The second key may have the command to fold the piece of paper twice about its width; the first fold at half of the width, and the second fold at three quarters of the width, so that a prospect-folder-like piece of paper is obtained. The third key may, for example, have the command to fold the piece of paper once about the middle axis of its width, and staple it afterwards. Of course, it should be understood that each of the keys may be programmed to perform other tasks, depending on the desires of a particular user.

FIG. 4b shows a user 9, handling the piece of paper 8, that is being finished by the device 1 from FIG. 4a. The portable storage device is still coupled to the USB connector 2, and further operation of the device can be controlled via the keyboard 6. The device is performing an operation that was demanded by the user via the keyboard 6.

The operation may have been selected from an overview of possible options that was presented to the user by configuration software on his PC, or it may have been pre-configured by a system administrator, who determines what option of the document finishing device are made available to a certain user.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims and/or embodiments may be applied in combination and any combination of such claims and/or embodiments are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for configuring a document finishing device, such as a folding, binding or stapling machine, comprising the steps of:
storing data relating to at least one command executable by at least one document finishing device on a portable data storage device;
connecting the portable data storage device to the document finishing device;
reading the stored data from the data storage device into the document finishing device; and
assigning the selected command to at least one physical key of the document finishing device, based on the data read from the data storage device.

2. The method according to claim 1, further comprising the steps of:
storing operating software for the document finishing device onto the portable data storage device prior to the step of connecting the portable data storage device to the document finishing device; and
updating the document finishing device with the operating software, after the step of connecting the portable data storage device to the document finishing device.

3. The method according to claim 1, further comprising the steps of:
generating a legend of the selected command; and
applying the legend on the at least one physical key of the document finishing device.

4. A document finishing device for performing the method according to claim 1, comprising:
at least one configurable physical key for entering at least one command to the device;
a data exchange interface for connecting the document finishing device to a portable data storage device;
a unit configured to read data from the data storage device;
a unit configured to assign at least one command to the at least one key, based on data read from the data storage device.
